(19) United States
(12) Patent Application Publication
(10) Pub. No.: US 2022/0342888 A1
(43) Pub. Date: Oct. 27, 2022

(54) OBJECT TAGGING

(71) Applicant: Nutanix, Inc., San Jose, CA (US)

(72) Inventors: Anand Varma Chekuri, Durham, NC (US); Kaustubh Gondhalekar, Durham, NC (US); Roger Liao, St. Louis, MO (US)

(73) Assignee: Nutanix, Inc., San Jose, CA (US)

(21) Appl. No.: 17/358,967

(22) Filed: Jun. 25, 2021

Related U.S. Application Data
(60) Provisional application No. 63/179,635, filed on Apr. 26, 2021.

(51) Int. Cl. G06F 16/2455; G06F 9/455; G06F 16/22; G06F 16/14

(52) U.S. Cl. CPC G06F 16/24553; G06F 9/45558; G06F 16/2255; G06F 16/148

(57) ABSTRACT

In accordance with some aspects of the present disclosure, a non-transitory computer readable medium is disclosed. The non-transitory computer readable medium includes instructions when executed by a processor cause the processor to receive, from a client, a tag-based object query including one or more parameters, map, using an index, the one or more parameters to a list of object names of corresponding objects stored in an object store, and provide, to the client, the list of object names. In some embodiments, the one or more parameters includes a tag. In some embodiments, the index and the object store are maintained natively. In some embodiments, the index and the object store are part of a flat namespace.

### CROSS-REFERENCE TO RELATED APPLICATION

This application is related to and claims priority under 35 U.S. § 119(e) from U.S. Provisional Application No. 63/179,635, filed Apr. 26, 2021, titled “OBJECT TAGGING,” the entire contents of which are incorporated herein by reference for all purposes.

### BACKGROUND

Virtual computing systems are widely used in a variety of applications. Virtual computing systems include one or more host machines running one or more virtual machines and other entities (e.g., containers) concurrently. Modern virtual computing systems allow several operating systems and several software applications to be safely run at the same time, thereby increasing resource utilization and performance efficiency. However, the present-day virtual computing systems have limitations due to their configuration and the way they operate.

### SUMMARY

In accordance with some aspects of the present disclosure, a non-transitory computer readable medium is disclosed. The non-transitory computer readable medium includes instructions when executed by a processor cause the processor to receive, from a client, a tag-based object query including one or more parameters, map, using an index, the one or more parameters to a list of object names of corresponding objects stored in an object store, and provide, to the client, the list of object names. In some embodiments, the one or more parameters includes a tag. In some embodiments, the index and the object store are maintained natively. In some embodiments, the index and the object store are part of a flat namespace.

In some aspects, the index is a key-value structure, the key includes the one or more parameters, and the value includes the list of objects. In some aspects, the tag includes a tag key-value pair. In some aspects, the one or more parameters includes one or more of a hash of a concatenation of a bucket identifier (ID) and partition ID, a bucket ID, and a hash of a first object name.

In some aspects, the one or more parameters are encoded with a prefix. In some aspects, the tag-based query specifies the objects corresponding to the list of objects to expire. In some aspects, the tag-based query provides a user access to the objects corresponding to the list of objects.

In accordance with some aspects of the present disclosure, an apparatus is disclosed. In some embodiments, the apparatus includes a processor and memory. In some embodiments, the memory includes instructions that, when executed by a processor, cause the apparatus to receive, from a client, a tag-based object query including one or more parameters, map, using an index, the one or more parameters to a list of object names of corresponding objects stored in an object store, and provide, to the client, the list of object names. In some embodiments, the one or more parameters includes a tag. In some embodiments, the index and the object store are maintained natively. In some embodiments, the index and the object store are part of a flat namespace.

In accordance with some aspects of the present disclosure, a computer-implemented method is disclosed. The method includes receiving, from a client, a tag-based object query including one or more parameters, mapping, using an index, the one or more parameters to a list of object names of corresponding objects stored in an object store, and providing, to the client, the list of object names. In some embodiments, the one or more parameters includes a tag. In some embodiments, the index and the object store are maintained natively. In some embodiments, the index and the object store are part of a flat namespace.

The foregoing summary is illustrative only and is not intended to be in any way limiting. In addition to the illustrative aspects, embodiments, and features described above, further aspects, embodiments, and features will become apparent by reference to the following drawings and the detailed description.

### BRIEF DESCRIPTION OF THE DRAWINGS

FIG. 1 is an example block diagram of an object system, in accordance with some embodiments of the present disclosure.

FIG. 2 is a flowchart of an example method of writing atomically, in accordance with some embodiments of the present disclosure.

FIG. 3 is a flowchart of an example method of executing a tag-based query, in accordance with some embodiments of the present disclosure.

The foregoing and other features of the present disclosure will become apparent from the following description and appended claims, taken in conjunction with the accompanying drawings. Understanding that these drawings depict only several embodiments in accordance with the disclosure and are therefore, not to be considered limiting of its scope, the disclosure will be described with additional specificity and detail through use of the accompanying drawings.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and made part of this disclosure.

A workload in a virtualized environment can be configured to run software-defined object storage service. The workload (e.g., virtual machines, containers, etc.) may be configured to deploy (e.g., create) buckets, add objects to the buckets, lookup the objects, version the objects, tag the objects, maintain the lifecycle of the objects, control access of the objects, delete the objects, delete the buckets, and the like, using one or more application programming interfaces (APIs). A bucket is like a folder except that a bucket has a flat hierarchy, whereas a folder has recursion (e.g., sub-folders). The buckets can be backed by physical storage resources that are exposed through a hypervisor. The buckets can be accessed with an endpoint such a uniform resource locator (URL). An object can be anything: a file, a document, a spreadsheet, a video, data, unstructured data, metadata, etc.

Object tagging may associate user-defined key-value pairs with objects. Some embodiments lacking the improvements disclosed herein require a user to scan all objects in a bucket or object store to locate a desired object. Such embodiments can be computationally expensive and slow. Moreover, such embodiments incur great central processing unit (CPU) and network costs to synchronize between disparate databases, making atomic operations exceedingly costly. What is needed is a way of efficiently filtering massive amounts of objects to a sensible list and maintaining consistency of object data, metadata, and tagging storage structures.

Disclosed herein are embodiments of a system and method for tagging objects and performing tag-based queries. In some embodiments, tags can be mapped to a list of object names of objects located in an object store. In some embodiments, the object store and the structure that stores the tags are maintained natively and belong to a flat namespace. Further disclosed herein are embodiments of a system and method for atomically updating object metadata and object tags, which may be in separate storage structures.

Advantageously, in one aspect, by arranging the storage structures to be native to an object system, the tag-based query and the atomic update can incur less latency than if at least one of the data structures was external and at least one request propagates to the external structure. In one aspect, multiple storage structures (e.g., object store, metadata store, tagging database and indexing database) have a flat namespace. One benefit to a flat namespace is that there is no hierarchy to traverse and finding an object of any name incurs the same latency. In addition, in some embodiments, having a flat namespace enables even distribution of the namespace across multiple metadata servers. For example, entries of object, tag, and tag-index can be arranged in such a way that they correspond to the same metadata server node, thus executing the request atomically and providing strong consistency guarantees (as opposed to eventual consistency when one of the storage structures is an external entity having a different namespace). Some embodiments lacking the improvements disclosed herein combine native services having flat namespace with an external service, which results in a non-flat namespace.

Applications for tags and tag-based queries can include enhancing life cycle management and access control. In some embodiments, while configuring life cycle policies, a client or can specify tags as an additional filter. For example, a client can specify to expire all objects being associated with one or more parameters such as a first bucket, a first prefix, and a first tag key-value pair. In some embodiments, a client can specify tag filters for access control. For example, a client can grant access to a user for all objects associated with one or more parameters such as a first bucket, a first prefix, and a first tag key-value pair. In addition, lists of objects can be provided based on tags and tag-based queries.

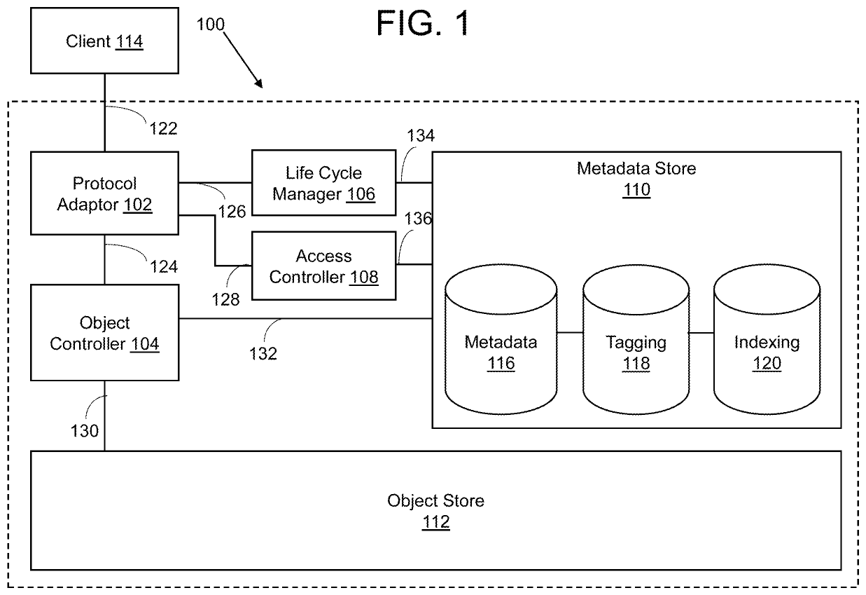

FIG. 1 is an example block diagram of an object system 100, in accordance with some embodiments of the present disclosure. The object system 100 can be in communication with a client 114. The client 114 can include an internal component of the object system 100 or an external component such as a Simple Storage Service (S3) client. In some embodiments, the client 114 is operated by a user (e.g., human user) or a user interface, while in other embodiments, the client 114 is operated by an automated service or script.

In some embodiments, the object system 100 includes a number of components that communicate to each other through APIs. In some embodiments, each of the components is a microservice. In some embodiments, the object system (e.g., object store system) 100 includes the protocol adaptor 102. The protocol adaptor 102 receives APIs 122 from the client 114. The APIs 122 may be standardized APIs such as Representational State Transfer (REST) APIs, S3 APIs, APIs native to the object system 100, etc. In some embodiments, the protocol adaptor 102 converts (e.g., transforms, encodes, decodes, removes headers of, appends headers of, encapsulates, de-encapsulates) the APIs 122 to generate APIs that are native to the object system 100. In some embodiments, the protocol adaptor 102 sends the converted API (e.g., API 124, API 126, or API 128) to another component in the object system 100 that is in communication with the protocol adaptor 102, while in other embodiments, the protocol adaptor 102 forwards the API 122 to another component in the object system 100.

The APIs (e.g., API requests, API queries) 122 can include one or more instructions (e.g., commands, requests, queries, calls) to write/create, update, read (e.g., find, fetch, return), or delete an object, object data, object metadata, or a tag associated with an object, and read or filter an object or an object list based on one or more tags, although any number of various APIs are within the scope of the present disclosure. The APIs 122 can include one or more parameters (e.g., properties, attributes), keys, and/or hashes that can be mapped to various values.

In some embodiments, the object system 100 includes the object controller 104 in communication with the protocol adaptor 102. The object controller 104 can receive APIs 124 from the protocol adaptor 102. The object controller 104 may include programmed instructions to serve/respond to the APIs 124. The object controller 104 may send to an object store 112 one or more APIs 130 that operate on (e.g., read, create, update, delete, etc.) one or more objects stored or to be stored in the object store 112. In some embodiments, the object controller 104 sends one or more APIs 132 to the metadata store 110. The API 132 may be a request to operate on a tag. The APIs 132 may be part of serving a request to operate on an object associated with the tag.

In some embodiments, the object system 100 includes the life cycle manager 106 in communication with the protocol adaptor 102. The life cycle manager 106 can receive APIs 126 from the protocol adaptor 102 and serve/respond to the APIs 126. The life cycle manager 106 may include programmed instructions and/or send one or more APIs 134 to the metadata store 110 to configure life cycle policies. Life cycle policies may include life cycle management, audits, and background maintenance activities.

In some embodiments, the object system 100 includes the access controller 108 in communication with the protocol adaptor 102. The access controller 108 can receive APIs 128 from the protocol adaptor 102 and serve/respond to the APIs 128. The access controller 108 may include programmed instructions and/or send one or more APIs 136 to the metadata store 110 to configure access control.

In some embodiments, the object system 100 includes the metadata store 110 in communication with the object controller 104. The metadata store 110 includes a number of data structures including a metadata structure (e.g., metadata mapping structure, metadata database, metadata map) 116 for storing and mapping/correlating/corresponding/associating metadata (e.g., a location of an object, a time of a last object write, a latest version of the object, etc.) to/with each object, a tagging structure (e.g., tagging mapping structure, tagging database, tag map) 118 for storing one or more tags and mapping each object to one or more tags, and an indexing structure (e.g., indexing mapping structure, indexing database, indexing map, index, tag index map, index tag map) 120 for mapping each tag to one or more objects. Each structure can be in a container, either by itself or with other components. In some embodiments, each of the data structures is backed by a respective volume of a file system and/or a respective disk of a block storage facility. In some embodiments, the metadata store 110 includes, or is coupled to, a metadata service/server/processor for servicing APIs (e.g., mapping keys to values using one of the structures) received by the metadata store 110.

In some embodiments, the tagging structure 118 is separate from the metadata structure 116. One benefit of decoupling tagging information from metadata may be that a client 114 does not incur the computational (e.g., CPU usage, memory usage, network/PO usage, IOPS, latency) cost, during scans and reads, of reading tagging information as part of an object request or updating object metadata as part of a tagging request. Moreover, keeping separate structures may reduce a size of each structure, which may lead to faster scans and reads of each structure. In other embodiments, the tagging structure 118 is combined with the metadata structure 116. In such embodiments, the metadata store 110 may store tags as optional fields/columns in object user metadata entries/rows in the combined structure. One advantage of a combined structure is that a single query can handle metadata and tagging reads or writes/updates, which reduces a likelihood that only a partial update happens in a crash event.

In some embodiments, each tag includes a tag key-value pair (e.g., tag key and a tag value returned by the tag key). Advantageously, having tag values adds one more level of categorization compared to only having tag keys. In some embodiments, the tag key is included in another key sent in an API/query and the tag value is included in another value sent in response to the API/query. In other embodiments, the tag key and the tag value are included in the other key sent in an API/query. In yet other embodiments, the tag key and the tag value are included in the other value sent in response to the API/query.

In some embodiments, keys for a given bucket can be in one metadata store 110 associated with one bucket or one bucket partition, while in other embodiments, keys can be distributed (e.g., scattered, spread) across multiple metadata stores 110 associated with multiple buckets or bucket partitions. Advantageously, distributing keys across multiple metadata stores 110 can reduce storage overhead on a single metadata store by storing the entire index on multiple nodes, particularly if there are many objects associated with a same tag. By leveraging multiple nodes, they can share the storage footprint.

In some embodiments, each of the maps have a row-column configuration (e.g., a key layout), wherein an object (e.g., or tag) corresponds to a row, and each of the parameters corresponds to one column of that row. The parameters may include components of a key and a value that is returned by that key. In one aspect, a first key layout for the tagging structure 118 includes a key and a value. The key may include a hash of a concatenation of a bucket identifier (ID) and partition (e.g., bucket partition) ID, a bucket ID, an object name, a version number, and a tag key, and the value may include a tag value, although additional or alternative parameters in the key or value are within the scope of the present disclosure. For example, the hash can be of the bucket ID instead of the bucket ID concatenated with the partition ID. In some embodiments, the first key layout does not result in collisions. In another aspect, a second key layout for the tagging structure 118 is the same as the first key layout except that the key includes a hash of the object name instead of the object name and the value additionally includes the object name. Advantageously, the second key layout may reduce a size of the second key layout as compared to the first-key layout (e.g., may reduce by as much as 1024 bytes). In some embodiments, the second key layout does not result in collisions irrespective of its reduction in size. In another aspect, a third key layout for the tagging structure 118 can be used to retrieve all tags associated with an object with a single read request, which can be less computationally expensive than a scan request. For example, the third key layout is similar to the second key layout except that the tag key resides in the value rather than the key. Thus, in some embodiments, every object name can have a list of <tag key, tag value> associated with it.

In some embodiments, one or more of the APIs 132, 134, and 136 include tagging APIs. The metadata store 110 can be responsive to the tagging APIs. The tagging APIs can include PUT object tagging which adds or updates a tag entry to the tagging structure 118. The tagging APIs can include GET object tagging, which reads, from the tagging structure 118, a key that includes an object name and returns one or more tag-key-value pairs corresponding to the object name. The tagging APIs can include DELETE object tagging, which deletes a tag entry in the tagging structure 118.

In some embodiments, one or more of the APIs 132, 134, and 136 include object APIs. The metadata store 110 can be responsive to the object APIs. In some embodiments, the object APIs include steps/instructions directed to tagging. For example, a POST object or a PUT object adds provided tag key-value pairs to the tagging structure 118 (e.g., in a row associated with the object being created). In some embodiments, a PUT-REPLACE object or a PUT-COPY object replaces tag key-value pairs from a source object with tag key-value pairs provided when copying the object metadata, or copying old tag key-value pairs, respectively. In some embodiments, a GET object reads the tagging structure 118 to get a tag count for the corresponding object and the tag count is returned as a header.

In some embodiments, the writes (e.g., PUT/POST object requests) directed to object metadata and tagging metadata are atomic (e.g., at a same time, or substantially at the same time, such as within 1 ns or 1 us of each other). In some embodiments, the object metadata and tagging metadata can reside (e.g., be stored) on separate structures, the object controller 104 can make a first call to the metadata store 110 to update tagging metadata, and the object controller 104 can make a second call to the metadata store 110 to update object metadata. In such embodiments, if a crash event occurs, the tagging metadata (or the object metadata, if updated first) can get garbage collected. In some embodiments, the object metadata and tagging metadata can reside on a combined structure, the object controller 104 can make a single call to the metadata store 110, and the combined structure can handle the update atomically.

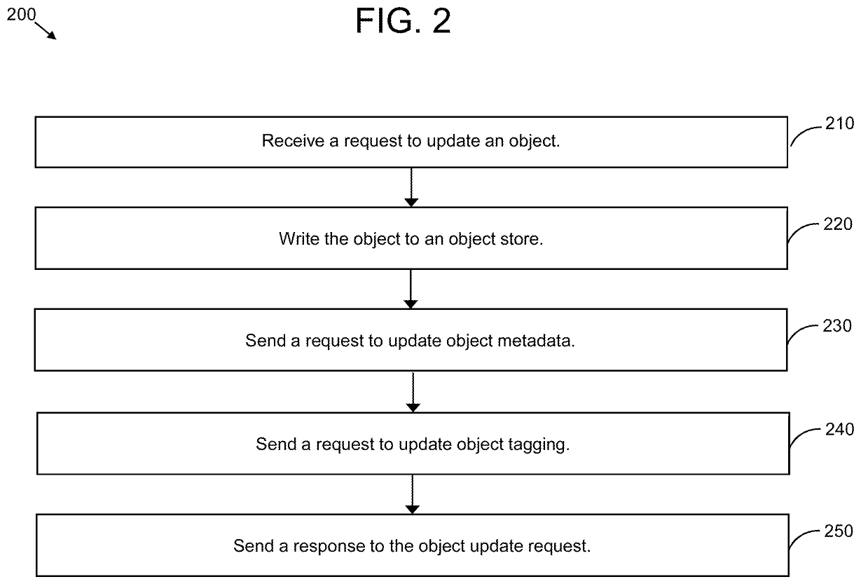

Referring now to FIG. 2, a flowchart of an example method 200 of writing atomically is illustrated, in accordance with some embodiments of the present disclosure. In some embodiments, writing atomically is a challenge because recipients of the APIs (e.g., the metadata store 110, the object store 112) may be, or include, different microservices, or other structures, from each other. The method 200 may be implemented using, or performed by, the object system 100, one or more components of the object system 100, or a processor associated with object system 100 or the one or more components of object system 100. Additional, fewer, or different operations may be performed in the method 200 depending on the embodiment.

In some embodiments, a processor (e.g., the object controller 104) receives a request (e.g., API 122/124 from the client 114, via the protocol adaptor 102) to update an object (at operation 210). In some embodiments, the processor writes (e.g., sends an API 130) the object to an object store (e.g., the object store 112) (at operation 220). In some embodiments, the processor sends a second request (e.g., a first API 132 to the metadata store 110, e.g., the metadata structure 116 or a combined structure) to update object metadata associated with the object (at operation 230). In some embodiments, operations 220 and 230 are performed in parallel. In some embodiments, operations 220 and 230 are done at separate times but each of the first and second request include an instruction to be executed at a predetermined time such that the requests are executed in parallel. In some embodiments, the processor sends a third request (e.g., a second API 132 to the metadata store 110, e.g., the tagging structure 118, or as part of the first API 132) to update object tagging associated with the object (at operation 240). In some embodiments, the third request is in parallel with the first two requests or includes an instruction to be executed at the predetermined time. In some embodiments, the processor sends a response to the object update request (at operation 250).

In some embodiments, the method 200 can be performed by the metadata store 110. For example, a processor (e.g., the metadata store 110) receives a first request (e.g., from the object controller 104) to update object metadata associated with an object updated by the object controller 104. In some embodiments, the processor updates the object metadata in response to the first request. In some embodiments, the processor receives a second request (e.g., from the object controller 104) to update object tagging associated with the object. In some embodiments, the processor updates the object tagging in response to the second request.

The method 200 has various benefits. One benefit is that a write for object metadata and object tagging can be done together from a single request. Other implementations lacking the improvements herein may separate these two calls, which may not provide an atomic guarantee. Another benefit is that by writing atomically, the metadata structure 116 and the tagging structure 118 can be synchronized with each other. In some embodiments, the metadata structure 116 and the tagging structure 118 are native to the object system 100. Yet another benefit is that, by arranging the metadata structure 116 and the tagging structure 118 to be native to the object system 100, the atomic write can incur less latency than if at least one of the metadata structure 116 and the tagging structure 118 was external and at least one request propagates to the external structure.

Referring now back to FIG. 1, the indexing structure 120 can be used to support queries to fetch objects with a given tag key. In one aspect, a first key layout for the indexing structure 120 includes a key and a value. The key may include a hash of a concatenation of a bucket identifier (ID) and partition ID, a bucket ID, a tag key, a tag value, and a hash of an object name, and the value may include a list of an object name and a list of each version number for each object name in the list of object names, although additional or alternative parameters in the key or value are within the scope of the present disclosure. In another aspect, a second key layout for the indexing structure 120 is the same as the first key layout except that the key includes the version number instead of the value including the version number. Other key layouts can be supported, irrespective of whether fetching objects with a given tag key is supported. In another aspect, a third key layout for the indexing structure 120 can be similar to one of the key layouts for the tagging structure 118. In another aspect, a fourth key layout for the indexing structure 120 can be similar to the second key layout except that the key includes the object name instead of the hash of the object name, and the value does not include the object name. In some embodiments, the life cycle manager 106 can maintain one or more of the metadata structure 116, the tagging structure 118, or the indexing structure 120.

In some embodiments, the tag-based query can include an entire tag key, while in other embodiments, the tag-based query can include a portion (e.g., a starting portion) of the tag key and omit a remaining portion of the tag key. In some embodiments, the tag-based query can include all of the parameters associated with the key, while in other embodiments, the tag-based query can include some of the parameters (e.g., the hash of the concatenation of the bucket identifier (ID) and partition ID, the bucket ID, and the tag key) associated with the key while omitting other parameters associated with the key.

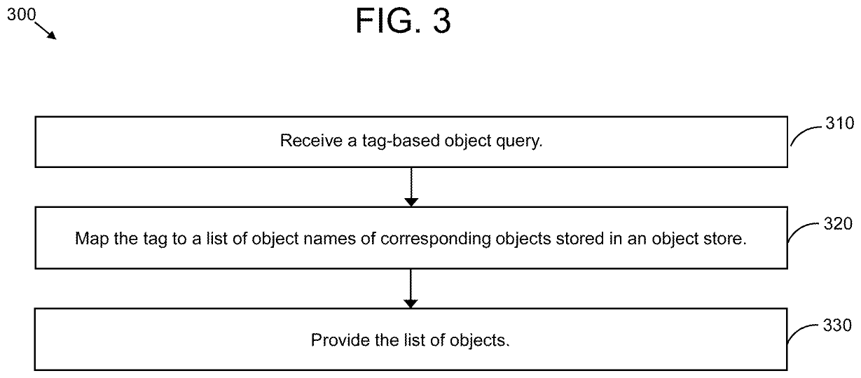

Referring now to FIG. 3, a flowchart of an example method 300 of executing a tag-based query is illustrated, in accordance with some embodiments of the present disclosure. The method 300 may be implemented using, or performed by, the object system 100, one or more components of the object system 100, or a processor associated with object system 100 or the one or more components of object system 100. Additional, fewer, or different operations may be performed in the method 300 depending on the embodiment. One or more operations of the method 300 can be combined with one or more operations of the method 200.

In some embodiments, a processor (e.g., the metadata store 110 of the object system 100) receives a tag-based object query (e.g., API 122/124 from the client 114, via the protocol adaptor 102 and the object controller 104) (at operation 310). In some embodiments, the tag-based object query includes one or more parameters such as a tag (e.g., a tag key-value pair, a tag key, or a tag value). In some embodiments, the processor maps (e.g., using an index, e.g., the indexing structure 120) the one or more parameters to a list of object names of corresponding objects stored in an object store (e.g., the object store 112) (at operation 320). In some embodiments, the index and the object store are maintained natively. In some embodiments, the index and the object store are part of a flat (e.g., single, global) namespace. In some embodiments, the processor provides (e.g., to the client) the list of object names (at operation 330). In some embodiments, the processor provides, for each object name, a list of object versions corresponding to that object name.

In some embodiments, the index is a key-value structure (e.g., an LSM), the key includes the one or more parameters, and the value includes the list of objects. In some embodiments, the one or more parameters includes one or more of a hash of a concatenation of a bucket identifier (ID) and partition ID, a bucket ID, and a hash of a first object name. In some embodiments, the one or more parameters are encoded with a prefix (e.g., a common prefix). In some embodiments, the tag-based query specifies the objects corresponding to the list of objects to expire. In some embodiments, the tag-based query provides a user access to the objects corresponding to the list of objects.

In some embodiments, the method 300 can be performed by a processor in, and/or executing instructions of, one or more of the object controller 104, the life cycle manager 106, or the access controller 108. For example, the processor provides (e.g., to a metadata store such as the metadata store 110) a tag-based object query (e.g., API 124). The tag-based query can include a portion (e.g., a starting portion) of the tag key. In some embodiments, the metadata store maps, using an index, the tag to a list of object names of corresponding objects stored in an object store. In some embodiments, the processor receives (e.g., from the metadata store) the list of object names.

The method 300 has various benefits. In one aspect, a user or service can fetch a list of object names corresponding to a tag (e.g., a user created tag or a system created tag) and can provide further queries on that subset of objects rather than all the objects in a bucket, object store, etc. In another aspect, the object store 112 and the indexing structure 120 are native to the object system 100. A benefit is that, by arranging the object store 112 and the indexing structure 120 to be native to the object system 100, the tag-based query can incur less latency than if at least one of the object store 112 and the indexing structure 120 was external and at least one request propagates to the external structure. In another aspect, a benefit of having a flat namespace for the indexing structure 120 and the object store 112 is that any identifier, key, value, etc. is unique across all storage structures.

The metadata store 110 (e.g., one or more of the metadata structure 116, the tagging structure 118, or the indexing structure 120) may include a log-structured merge (LSM) tree based key-value (KV) store. In some embodiments, the LSM tree based KV store includes a Commitlog, a MemTable, and SSTables. The Commitlog and sorted string tables (SSTables) can be on-disk (e.g., persistent) while the Memtable can be an in-memory (e.g., transitory) data structure. The Commitlog is an append-only file which can be used as a log for recovery purposes. The Memtable can be used to absorb writes and speed up the write path. The SSTables are sorted, immutable files which can store all the key-value pairs persistently. The SSTables may be divided into multiple levels, with each level having larger SSTables than the one before it.

An LSM tree's write/update path is described herein. An update to a key is treated as a new write and does not update the previous value for the key. Advantageously, writes may be faster as it does not search for the previously written value and then update it.

The write path may include appending the Commitlog file with the key-value pair and then updating the Memtable. All writes can be sequentially written to the Commitlog and if writes come in parallel, they can be serialized while writing to it. Once the Memtable or the Commitlog crosses a predefined limit, the Memtable content can be written into the disk(flushing) to create an SSTable. In some embodiments, the SStable contains the key-value pairs sorted based on the key. However, since the LSM may treat updates to keys as new writes, the LSM may have duplicate entries for the key in multiple S Stables where the newest S Stable always has the right value for the key. To clean up the older entries, LSM trees may perform compaction, which is described below.

In some embodiments, the LSM stores key-values contiguously. In some embodiments, the key and value fit into a same data block. In some embodiments, the data block size is increased to fit the key and value into the same data block. Advantageously, having the key and value in the same data block can minimize input/output (I/O) usage.

As described above, in some embodiments, lists (e.g., object name lists, object version lists) are stored in the value. In some embodiments, a read-modify-write is performed for mutations. In some embodiments, a merge is performed. In some applications such as where reading is not as time sensitive or computationally constrained as a writing, one benefit is that a cost of merge is during a read rather than during a write.

In some embodiments, the LSM supports prefix encoding. Advantageously, in some embodiments, prefix encoding stores a common key only once. In some embodiments, non-common attributes (e.g., object name, version number) are not included in the key, which can avoid space amplification.

An LSM's read process is described herein. In some embodiments, the read process includes searching for the value of the key in the Memtable and multiple SSTable files. In some embodiments, the LSM does all the querying in parallel to avoid wasting time on the Memtable or a single SSTable.

Some optimizations for the read path include consulting the most recent S Stables first since the newest entry and using bloom filters to filter out SSTables. In some embodiments, responsive to a bloom filter returning a value of false, the LSM may determine that the key does not exist in the SSTable.

The efficiency of the read path may depend on the number of SSTable files in the LSM since the LSM or client may have to do at least one disk I/O per SSTable file. The size amplification of the LSM tree directly impacts the read performance of the LSM tree.

Scan operations on the LSM may include finding all valid key-value pairs in the database, usually between a user-defined range. A valid key-value pair is one which has not been deleted. While each SSTable file and the memtables are sorted structures, they can have overlapping ranges. In some embodiments, a sorted view can still be built by merging the values from overlapping SSTables/memtables and returning the latest entries.

The LSM (e.g., an LSM iterator component of the LSM) may iterate through the keys for every SSTable. The LSM may discard the obsolete key-value pairs returned from older SSTables which have not been compacted yet.

Scans may be generally more challenging to solve in an LSM based key-value store than in a B-tree based store due to the presence of obsolete key-value pairs in older SSTables that may be skipped. Scan performance can be based on the number of SSTable files and the amount of obsolete key-value pairs present in the database. Reading obsolete key-value pairs can detrimentally impact CPU, memory and I/O bandwidth.

Compaction can clean up obsolete key-value pairs and reducereducing the number of SSTables in the database. Compaction may include selecting the SSTable files to perform compaction for (e.g., heuristics, machine learning, or other implementations), reading all the key-value pairs from the SSTables into memory and merge them together to form a single sorted stream (including removing the obsolete key-value pairs due to updates or deletes), writing the single sorted stream as a new SSTable file, and deleting the old SSTable files which are now obsolete.

Compaction may be CPU/memory intensive since it can maintain a large number of keys and has to perform merge-sort across multiple incoming sorted streams. Compaction can be I/O intensive since it can generate read and write working sets which can encompass an entire database and severely impact user-facing read/write/scan operations.

In some embodiments, the object system 100 includes the object store 112 in communication with the object controller 104. The object store 112 stores objects, in some embodiments. The object store 112 may include, but is not limited to, NVM such as NVDIMM, storage devices, optical disks, smart cards, solid state devices, etc. The object store 112 can be shared with one or more host machines. The object store 112 can store data associated with the one or more host machines. The data can include file systems, databases, computer programs, applications, etc. In some such embodiments the object store 112 can be a partition of a larger storage device or pool. In some embodiments, the object store 112 is a network-attached-storage such as a storage array network (SAN). In some embodiments, the object store 112 is a distributed fabric spread across multiple nodes, data centers, and/or clouds.

In some embodiments, the object store may be integrated with, or run on top of, a hyper-converged infrastructure (HCI) cluster (e.g., HCI, HCI cluster, cluster, etc.). An HCI cluster is one or more virtualized workloads (one or more virtual machines, containers, etc.) that run services/applications/operating systems by using storage and compute resources of one or more nodes (e.g., hosts, computers, physical machines, servers), or clusters of nodes, which are virtualized through a hypervisor. The cluster can be located in one node, distributed across multiple nodes in one data center (on-premises) or cloud, or distributed across multiple data centers, multiple clouds or data center-cloud hybrid.

Each of the components (e.g., elements, entities) of the object system 100 (e.g., the protocol adaptor 102, the object controller 104, the life cycle manager 106, the access controller 108, the metadata store 110, the object store 112, the metadata structure 116, the tagging structure 118, and the indexing structure 120), is implemented using hardware, software, or a combination of hardware or software, in one or more embodiments. Each of the components of the object system 100 may be a processor with instructions or an apparatus/device (e.g., server) including a processor with instructions, in some embodiments. Each of the components of the object system 100 can include any application, program, library, script, task, service, microservice, process or any type and form of executable instructions executed by one or more processors, in one or more embodiments. Each of the one or more processors is hardware, in some embodiments. The instructions may be stored on one or more computer readable and/or executable storage media including non-transitory storage media.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, unless otherwise noted, the use of the words “approximate,” “about,” “around,” “substantially,” etc., mean plus or minus ten percent.

The foregoing description of illustrative embodiments has been presented for purposes of illustration and of description. It is not intended to be exhaustive or limiting with respect to the precise form disclosed, and modifications and variations are possible in light of the above teachings or may be acquired from practice of the disclosed embodiments. It is intended that the scope of the invention be defined by the claims appended hereto and their equivalents.

What is claimed is:

1. A non-transitory computer readable medium comprising instructions when executed by a processor cause the processor to:
receive, from a client, a tag-based object query including one or more parameters, wherein the one or more parameters includes a tag;
map, using an index, the one or more parameters to a list of object names of corresponding objects stored in an object store, wherein the index and the object store are maintained natively and wherein the index and the object store are part of a flat namespace; and
provide, to the client, the list of object names.

2. The medium of claim 1, wherein the index is a key-value structure, wherein a key of the key-value structure includes the one or more parameters, and wherein a value of the key-value structure includes the list of objects.

3. The medium of claim 1, wherein the tag includes a tag key-value pair.

4. The medium of claim 1, wherein the one or more parameters includes one or more of a hash of a concatenation of a bucket identifier (ID) and partition ID, a bucket ID, and a hash of a first object name.

5. The medium of claim 1, wherein the one or more parameters are encoded with a prefix.

6. The medium of claim 1, wherein the tag-based query specifies the objects corresponding to the list of objects to expire.

7. The medium of claim 1, wherein the tag-based query provides a user access to the objects corresponding to the list of objects.

8. An apparatus comprising a processor and memory, wherein the memory includes instructions that, when executed by the processor, cause the apparatus to:
receive, from a client, a tag-based object query including one or more parameters, wherein the one or more parameters includes a tag;
map, using an index, the one or more parameters to a list of object names of corresponding objects stored in an object store, wherein the index and the object store are maintained natively and wherein the index and the object store are part of a flat namespace; and
provide, to the client, the list of object names.

9. The apparatus of claim 8, wherein the index is a key-value structure, wherein a key of the key-value structure includes the one or more parameters, and wherein a value of the key-value structure includes the list of objects.

10. The apparatus of claim 8, wherein the tag includes a tag key-value pair.

11. The apparatus of claim 8, wherein the one or more parameters includes one or more of a hash of a concatenation of a bucket identifier (ID) and partition ID, a bucket ID, and a hash of a first object name.

12. The apparatus of claim 8, wherein the one or more parameters are encoded with a prefix.

13. The apparatus of claim 8, wherein the tag-based query specifies the objects corresponding to the list of objects to expire.

14. The apparatus of claim 8, wherein the tag-based query provides a user access to the objects corresponding to the list of objects.

15. A computer-implemented method comprising:
receiving, from a client, a tag-based object query including one or more parameters, wherein the one or more parameters includes a tag;
mapping, using an index, the one or more parameters to a list of object names of corresponding objects stored in an object store, wherein the index and the object store are maintained natively and wherein the index and the object store are part of a flat namespace; and
providing, to the client, the list of object names.

16. The method of claim 15, wherein the index is a key-value structure, wherein a key of the key-value structure includes the one or more parameters, and wherein a value of the key-value structure includes the list of objects.

17. The method of claim 15, wherein the tag includes a tag key-value pair.

18. The method of claim 15, wherein the one or more parameters includes one or more of a hash of a concatenation of a bucket identifier (ID) and partition ID, a bucket ID, and a hash of a first object name.

19. The method of claim 15, wherein the one or more parameters are encoded with a prefix.

20. The method of claim 15, wherein the tag-based query specifies the objects corresponding to the list of objects to expire.
